(19) United States
(12) Patent Application Publication
(10) Pub. No.: US 2020/0311648 A1
(43) Pub. Date: Oct. 1, 2020

(54) RATING SYSTEM FOR LAW ENFORCEMENT

(71) Applicant: Nathalie Colbert, Latham, NY (US)

(72) Inventor: Nathalie Colbert, Latham, NY (US)

(21) Appl. No.: 16/834,215

(22) Filed: Mar. 30, 2020

Related U.S. Application Data
(60) Provisional application No. 62/825,246, filed on Mar. 28, 2019.

(51) Int. Cl. G06Q 10/06; G06F 16/487; G06F 16/483; G06Q 50/26

(52) U.S. Cl. CPC G06Q 10/06398; G06Q 50/26; G06F 16/483; G06F 16/487

(57) ABSTRACT

A rating system for law enforcement, wherein the system tracks interactions between law enforcement and citizens and retrievably stores textual, video and audio output associated with the interaction.

### CROSS-REFERENCE TO RELATED APPLICATION

This application claims the benefit of priority of U.S. provisional application No. 62/825,246 filed 28 Mar. 2019, the contents of which are herein incorporated by reference.

### BACKGROUND OF THE INVENTION

The present invention relates to law enforcement methodologies and, more particularly, to a rating system for law enforcement, wherein the system tracks interactions between law enforcement and citizens and retrievably stores textual, video and audio output associated with the interaction. Additionally, a related software application enables people to rate and review the related law-enforcement personnel involved in each interaction.

Police interactions can vary from community to community, even neighborhood to neighborhood. In some communities, the police the serve that community can be improved by instilling accountability, which in turn fosters greater respect for law enforcement and by extension the rule of law.

As can be seen, there is a need for a rating system for law enforcement interactions aimed at improving communication between police and their communities through giving people access to quantifiable information regarding the quality of police interactions in their towns. In short, the rating system for police gives their communities a method of applying accountability to peace officers, which to date is obscured by a lack of information and a code of silence. The rating system embodies a software application that rates individual police officers by badge number and couples and categorizes the professionalism of each police office through information related to police communication and response time.

### SUMMARY OF THE INVENTION

In one aspect of the present invention, a method of rating law enforcement involved in an interaction with at least one citizen includes the following: providing global positioning system data regarding a location of each interaction; associating each location with a precinct of law enforcement; and providing a database for retrievably storing video, audio, and textual output and a badge number associated with the location of each interaction, wherein the video, audio, and textual output comprises data from 911 calls, police dispatches, and police vests.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention; and

FIG. 2 is a continuation from FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rating system for law enforcement, wherein the system tracks interactions between law enforcement and citizens and retrievably stores textual, video and audio output associated with the interaction.

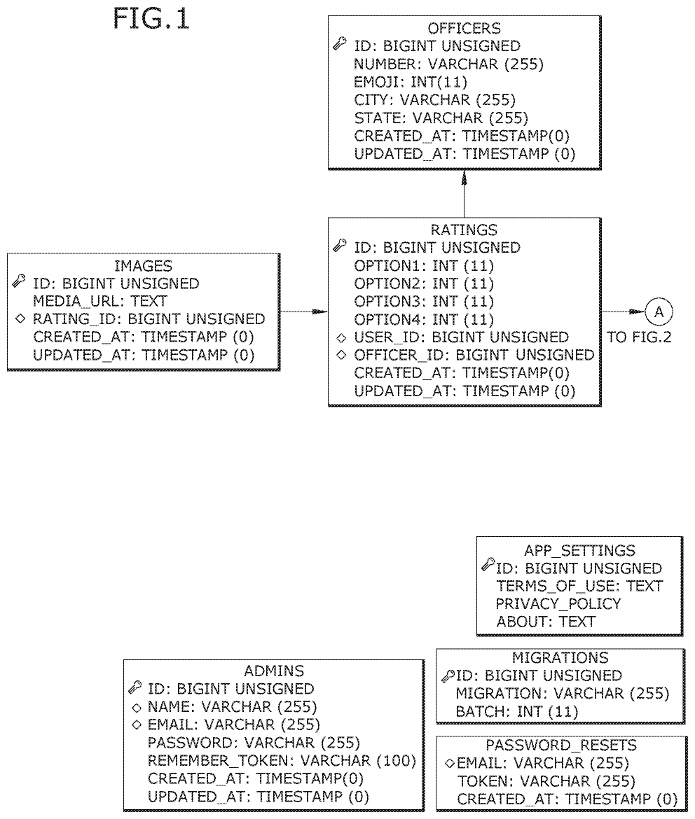

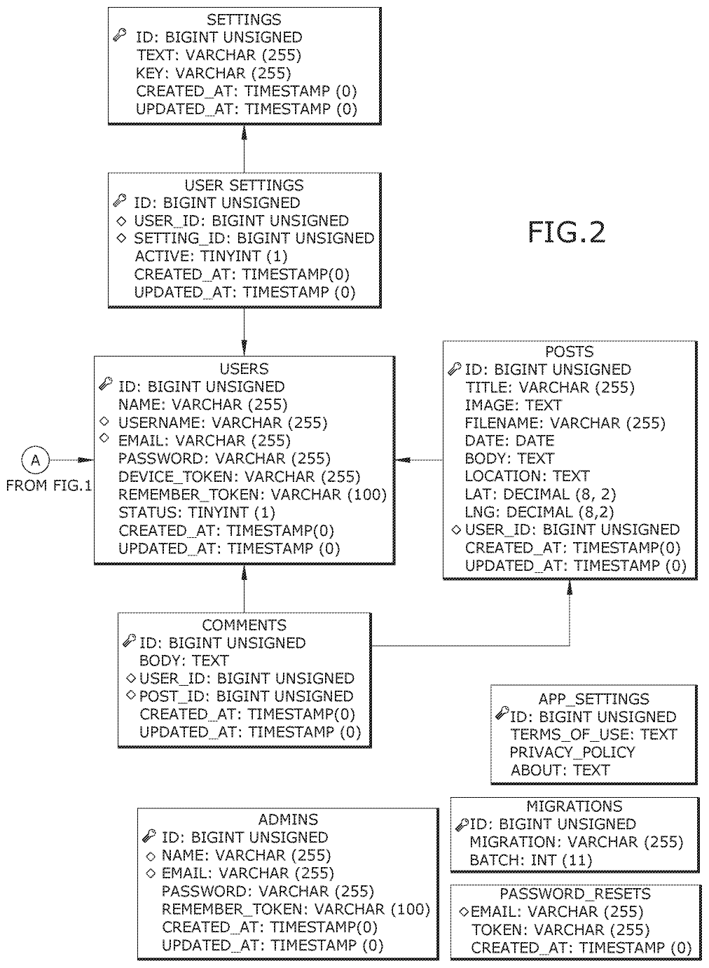

Referring to FIGS. 1 and 2, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The rating system incorporates a global positioning system (GPS) and a database of retrievably storing a badge number that can be associated with audio, video, and textual output. The audio output may include police communications, including audio of 911 operators, police dispatches and the like. Video (and audio) output may be output captured by a police vest, police vehicle, a third-party surveillance device. Textual information may include the police and or third-party summaries of the interaction (such as a journalist's report). The audio, visual, and textual output can be retrieved and stored by users who can identify a badge number of a specific police officer or a specific precinct number associated with the police officer(s) involved in any interaction. All of the above information can be retrieved through or can listen and view devices, and a link were people can automatically turn on audio and video on their device.

GPS is enabled so local areas can view individual ratings, law enforcement ratings as by tallied by area and location. GPS allow people to view ratings and review law enforcement anywhere they visit. The database allows any interaction to be retrievably stored so that users can decide to post that interaction on the sight. Linking 911 information will allow access to recordings in real-time as the incident happens. Systematic information may be exported to and from mobile devices.

The rating system enables users to rate law enforcement after any interaction. The law enforcement can rate them by categories that include professionalism, communication, attitude, response time, and overall experience. The interaction can be with or without audio and video input. The audio and video output of interactions can be uploaded or streamed live on the application. Integrating 911 data provides access to audio and video will increase better response time, incentivized by the accountability inherent in the present invention. Any interaction with law enforcement can be rated and reviewed as the textual, visual, and audio output associated with each interaction. In short, the present invention embodies an application that uses a different model to address a need for more accountability and clarity about the thin blue line.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of rating law enforcement involved in an interaction with at least one citizen, comprising:
providing global positioning system data regarding a location of each interaction;
associating each location with a precinct of law enforcement; and
providing a database for retrievably storing video, audio, and textual output and a badge number associated with the location of each interaction.

2. The method of claim 1, wherein the video, audio, and textual output comprises data from 911 calls, police dispatches, and police vests.
